(19) United States
(12) Patent Application Publication
(10) Pub. No.: US 2012/0143423 A1
(43) Pub. Date: Jun. 7, 2012

(54) DETERMINATION OF AMOUNTS OF ENERGY DRAWN

(75) Inventors: Thomas Theisen, Dorsten (DE); Armin Gaul, Selm (DE); Ingo Diefenbach, Unna (DE); Christian Rehtanz, Dortmund (DE); Willi Horenkamp, Dortmund (DE); Johannes Rolink, Emsburen (DE)

(73) Assignee: RWE AG, Essen (DE)

(21) Appl. No.: 13/333,162

(22) Filed: Dec. 21, 2011

Related U.S. Application Data
(63) Continuation of application No. PCT/EP2010/057200, filed on May 26, 2010.

(30) Foreign Application Priority Data
Jun. 22, 2009 (DE) 102009030090.2

(51) Int. Cl. G06F 17/00

(52) U.S. Cl. 701/22

(57) ABSTRACT

Method, system and device for determining quantities of power by registering on the vehicle side a quantity of power exchanged with a power point 12, transmission on the vehicle side of information concerning the first quantity of power, registering on the power point side of a total quantity of power formed from the sum of the first quantity of power and also a second quantity of power made available by the power point 12 independently of the electric vehicle 2, subtraction of the first quantity of power received by the vehicle 2 from the total quantity of power in order to determine the second quantity of power.

### CROSS-REFERENCE TO RELATED PATENT APPLICATION

This patent application is a continuation of International application No. PCT/EP2010/057200 filed on May 26, 2010, which claims the benefit of German application No. 102009030090.2 filed on Jun. 22, 2009, the teachings and disclosure of which are hereby incorporated in their entirety by reference thereto.

### FIELD OF THE INVENTION

The subject-matter relates to a method, a system and a device for determining quantities of power, in particular for determining quantities of power obtained by electric vehicles.

### BACKGROUND OF THE INVENTION

The distribution of electrically operated vehicles will increase rapidly in the near future. However, as electric vehicles operated with an electric motor become more popular, it must be ensured that these can be supplied with power in an extremely simple manner. To this end, a functional infrastructure must be provided.

In particular, the possibility of obtaining power for electric vehicles in public areas must be provided. For the ranges of electric vehicles of between fifty and a few hundred km that have been available to date, it is necessary for it to be possible to charge the vehicles also outside the domestic environment. To this end, charging stations must be provided in public areas in order to provide a constant availability of power for electric vehicles through a supply network. This availability is a main criterion for the acceptance of electric vehicles.

However, in the case of charging stations installed in public areas, it must be ensured that the customer pays for the power that is obtained. It must also be ensured that the power obtained by an electric vehicle is not billed to the person responsible for providing and operating the charging station. In the private sector too, it must be ensured that the quantity of power obtained by an electric vehicle is not billed to the homeowner or landlord providing and operating the power socket.

The obtaining of electric power and the feeding of electric power back into power sockets on the network presents a problem when the electric vehicles or hybrid vehicles are connected to normal power points (extraction point, tap connection) (i.e. power sockets of a charging station), which may be single-phase domestic power sockets or three-phase industrial power sockets. These are connected to conventional domestic or industrial power meters. In such a case, a separation between the power obtained by vehicles and power obtained for other reasons is not possible for billing purposes.

Current approaches to a solution assume that each individual power point is equipped with a separately installed power meter. An electric vehicle is then connected to this power point, and billing takes place on a per power point basis. The power point must have its own meter device and also logic so that billing for the power can take place on a per user . However, this power point is not suitable for billing separately on any other basis for the power obtained by electric vehicles.

For this reason, the object of the invention was to make domestic and/or industrial power sockets suitable for charging electric vehicles without having to equip each power socket with a separate meter. Another object was to allow the charging of electric vehicles at public and semi-public power sockets without these power sockets having to be equipped with separate meters.

### SUMMARY OF THE INVENTION

This object is achieved by a method for determining quantities of power, comprising the steps of registering by the vehicle a first quantity of power exchanged with a power point, transmission by the vehicle of information concerning the first quantity of power, integrally recording by the power point of a total quantity of power formed from the sum of the first quantity of power and also a second quantity of power made available by the power point independently of the electric vehicle, and subtraction of the first quantity of power received from the vehicle from the total quantity of power in order to determine the second quantity of power.

It has been discovered that power obtained by an electric vehicle can be billed separately from a total quantity of power only when the exchanged quantity of power is registered by the vehicle.

In this case, both an obtained quantity of power and also a quantity of power discharged to the network can be registered by the vehicle as the first quantity of power exchanged with a power point (extraction point, tap point). Obtained power can have a positive sign and discharged power can have a negative sign, so that the subtraction of the first quantity of power from the total quantity of power actually results in the second quantity of power. Preferably, a power meter is arranged on the vehicle, said power meter particularly preferably being calibrated. By means of this power meter, it is possible to register how big the quantity of power is that is exchanged with the power point, for example a mains power socket.

A programmed microprocessor may be arranged in the vehicle, for example for measurement purposes. The described method steps in the vehicle may be carried out by means of a computer program which has been implemented in the microprocessor of the vehicle.

After the exchanged quantity of power has been registered by the vehicle, this information is sent out by the vehicle. The quantity of power registered in the vehicle is thus made known outside the vehicle.

In addition, the total quantity of power is measured by the power point. The total quantity of power is the quantity of power which has been output via the power point, minus the power fed back into the network. The power point may in this case for example have a meter, to which there are connected on the one hand a plurality of power sockets for charging electric vehicles and on the other hand for example a domestic power network or an industrial power network. The domestic or industrial customer obtains power via the power point, and at the same time one or more electric vehicles can obtain power via the power point. The total quantity of power is thus composed of all the currents flowing through a particular meter, regardless of whether the power is being obtained or supplied by electric vehicles or by other consumers. The total quantity of power contains part of a first quantity of power made available to an electric vehicle by the power point, and also the second quantity of power made available by the power point independently of the electric vehicle.

In order to be able to separate for billing purposes the quantity of power obtained by the vehicle from the remaining quantity of power provided via the power point, it is proposed to subtract the value of the first quantity of power received from the vehicle from the value of the total quantity of power. If the value of the first quantity of power received from the vehicle is subtracted from the value of the total quantity of power, the second quantity of power or the value of the second quantity of power can be calculated. By way of example, a total quantity of power may be 10 kWh. The first quantity of power received from the vehicle may for example be such that 7 kWh have been obtained by the vehicle. If the 7 kWh obtained by the vehicle are then subtracted from the 10 kWh, the second quantity of power is calculated as 3 kWh. It is thus possible to bill the vehicle or the vehicle owner or some other entity associated with the vehicle for the 7 kWh received by the vehicle, and to bill the owner of the power point or the person responsible for drawing the power via the power point for the remaining 3 kWh.

By virtue of the solution according to the subject matter, it is possible to separate for billing purposes between the power obtained by the vehicle and the power obtained for other purposes. Electric vehicles can thus be charged at all available power sockets, provided that the power socket is equipped with a suitable meter for making available the corresponding communication link. The owners of the electric vehicles do not have to worry that the proprietor or operator of the power socket will be billed for the power obtained by them. Instead, it is ensured that the power obtained by the electric vehicles can be billed separately from the power obtained for other purposes.

It is preferred if the meter on the side of the power point is a so-called “smart meter”. Such a meter can be read remotely. Remote reading of such a meter may for example be TCP/IP-based. Remote reading of the meter may take place via a telephone network or a power supply network, for example by means of power line communication.

In order to be able to link the first quantity of power registered by the vehicle to the entity associated with the vehicle, which is responsible for paying the bill, it is proposed that a vehicle identifier which identifies the vehicle is sent out by the vehicle in particular with the information concerning the first quantity of power. It is thus possible to ascertain which vehicle has obtained the first quantity of power. By means of the vehicle identifier, it is possible to allocate a specific power tariff to the quantity of power obtained. By way of example, it is possible that, for each vehicle identifier, there is a particular power supply contract which defines the price for the power exchanged.

It may be possible to encrypt the vehicle identifier for data protection reasons. It may also be possible that the vehicle identifier is not associated directly with the vehicle, but rather is first encrypted via temporary identifiers and contract identifiers so that the quantity of power obtained cannot be associated directly with the vehicle but rather only directly with an owner.

According to one advantageous embodiment, it is proposed that information concerning the first quantity of power together with the vehicle identifier is received by the power point. According to this embodiment, the vehicle transmits the information concerning the quantity of power obtained together with the vehicle identifier to the power point. Communication between the vehicle and the power point may take place for example by means of power line communication. In this case, the charging cable may for example be used directly. Other transmission paths, for example wireless transmission paths between the vehicle and the power point, for example by means of near-field communication (NFC), WLAN, ZigBee, Bluetooth, or wired communication by means of a communication cable is possible. The communication may be TCP/IP-based. Other packet-switched or circuit-switched protocols are likewise possible. The communication may take place via the charging cable itself or else separately from the charging cable.

The information concerning the first quantity of power can be received in the power point together with the vehicle identifier, so that these two values can be further processed in a manner associated with one another.

If the first quantity of power is received in the power point together with the vehicle identifier, it is possible according to one advantageous embodiment that, in the power point, the value of the first quantity of power received by the vehicle is subtracted from the value of the total quantity of power. This makes it possible to determine the second quantity of power. As mentioned in the introduction, the total quantity of power is integrally registered by the power point, without it being possible for the power point to distinguish the first from the second quantity of power during this registration. By subtracting the value of the information concerning the first quantity of power received by the vehicle from the value of the total quantity of power, it is possible to determine the second quantity of power in the power point. To this end, a microprocessor for example may be arranged in the power point.

A computer program may be loaded in the power point, which computer program is programmed to carry out the operations which are mentioned in connection with the power point.

According to one embodiment, it is proposed that information concerning the second quantity of power together with a power point identifier is sent out by the power point. It is also proposed that information concerning the first quantity of power together with the vehicle identifier received by the power point is sent out by the power point. This transmission may take place for example via the power supply lines of the power supply network. It is also possible that this transmission takes place via (further) wired or also wireless wide area networks. In this case, use may be made for example of a mobile telephone network, for example a GSM, UMTS, LTE network. It is also possible that the transmission takes place via some other communication network. Some other wireless standard, for example WLAN, may also be used. In the power point, on the one hand the vehicle identifier and the first quantity of power are known. This information can be used for billing purposes, in order to be able to bill for the power obtained by the vehicle. In addition, the second quantity of power may have been calculated in the power point, which together with the power point identifier can be used to bill the proprietor/operator of the power point for the power obtained for other purposes.

It is also proposed that information concerning the second quantity of power together with the power point identifier and information concerning the first quantity of power together with the vehicle identifier are received in a central computer. The central computer may be for example a billing centre.

A programmed microprocessor may for example be arranged in the central computer. The method steps taking place in the central computer can be carried out by a computer program which has been programmed into the microprocessor of the central computer.

The central computer may contain communication means which can receive the information transmitted by the power point. In this case, the central computer may support the same communication protocols as the power point, so that flawless communication can take place.

Once the information concerning the second quantity of power together with the power point identifier and the information concerning the first quantity of power together with the vehicle identifier have been received in the central computer, billing can take place. To this end, at least a first data set comprising information about the second quantity of power and a power point identifier is assembled in the central computer. In addition, at least a second data set comprising information about the first quantity of power and the vehicle identifier can be created.

By means of the first data set, it is possible to bill the proprietor of the power point for the power obtained for other purposes. This may take place for example according to a first power tariff. Via the second data set, the first quantity of power can be billed to the vehicle owner or to the person responsible for paying the bills for the power obtained by the vehicle. The first data set thus forms the billing basis for the power obtained for other purposes, and the second data set forms the billing basis for the power obtained by the vehicle.

According to a further embodiment, it is proposed that a power point identifier sent out by the power point is received by the vehicle. In this case, this information may be exchanged for example via the charging cable which connects the vehicle to the power point. A separate communication line may also be used to exchange this information. In addition, use may be made for example of a near field communication (NFC) or some other abovementioned communication path and some other abovementioned communication protocol between the vehicle and the power point.

The power point identifier stored in the power point may also be read by means of an RFID reader in the vehicle.

The power point identifier may also be transmitted in encrypted form.

After the power point identifier has been received in the vehicle, it is possible that information concerning the first quantity of power together with a power point identifier and a vehicle identifier are sent out by the vehicle. This sending out may take place for example via a mobile telephone network. Other wireless technologies are also possible. This transmission may also take place via the charging cable which is connected to the power point and thereafter to a power supply network.

According to one embodiment, the information sent out by the vehicle may be received in a centrally arranged computer. The centrally arranged computer may be arranged for example in the power supply network. It is also possible that the centrally arranged computer is a computer arranged outside the power supply network, which is designed for billing the quantities of power relating to the vehicle. The information concerning the first quantity of power together with the power point identifier and the vehicle identifier can be received in this centrally arranged computer.

In the centrally arranged computer, it is thus possible that at least the first quantity of power, with the aid of the received vehicle identifier, is associated with a vehicle owner and/or with a particular power supply contract for power for electric vehicles.

According to one embodiment, it is proposed that information concerning the total quantity of power together with a power point identifier is sent out by the power point. This may take place for example via power line communication via the power supply network, so that a computer arranged in the power supply network can receive this information. Communication via a wireless network or a mobile telephone network or else a wired telecommunications network is also possible.

According to one embodiment, it is proposed that information concerning the total quantity of power together with the power point identifier is received in a centrally arranged computer. This centrally arranged computer may be different from the previously described centrally arranged computer which receives information concerning the first quantity of power together with the power point identifier and the vehicle identifier. These two central computers may also be arranged in one unit. The information transmitted by the power point concerning the total quantity of power together with the power point identifier can be received by the network.

At least information concerning the total quantity of power and the power point identifier is thus known to the network as first information, and information concerning the first quantity of power together with the power point identifier and the vehicle identifier is known to the network as second information. By exchanging the first and second information between the two centrally arranged computers or within the centrally arranged computer and by comparing the power point identifiers in the first information and the second information, it is possible that the total quantity of power of a particular power point is associated with a first quantity of power of this power point. This means that it is possible, by means of the power point identifier, firstly to discover the first quantity of power that has been obtained from the identified power point. In addition, it is possible to discover the total quantity of power that has been obtained from this power point, and to associate this with the previously determined first quantity of power.

By means of this association of the power point identifier with the total quantity of power and also the first quantity of power, it is possible in the network to subtract the value of the first quantity of power received by the vehicle from the value of the received total quantity of power and thus to calculate the second quantity of power in a centrally arranged computer in the network.

After the second quantity of power has been calculated by the network and a power point identifier has been able to be associated with it, then according to one embodiment a first data set comprising information about the second quantity of power and the power point identifier can be created. This first data set can be used for billing for the power obtained via the power point for other purposes. In addition, a second data set can be created which contains information about the first quantity of power and the vehicle identifier. This second data set can be used for billing for the power obtained by the vehicle.

Another subject matter is a system for determining quantities of power, comprising a first meter means on the vehicle side for registering a first quantity of power exchanged with a power point on the power supply network side, sending means on the vehicle side for sending out information concerning the first quantity of power, a second meter means on the power point side for integrally registration a total quantity of power formed from the sum of the first quantity of power and also a second quantity of power made available by the power point independently of the electric vehicle, and computing means for subtracting the first quantity of power received by the vehicle from the total quantity of power in order to determine the second quantity of power.

By means of this system, it is possible for billing purposes to separate the vehicle power from the rest of the power.

According to one embodiment, the first meter means is calibrated. In particular, the first meter means is a calibrated power meter. The power meter may be remotely readable. The power meter may be arranged in the vehicle and may communicate with communication means in the vehicle or may have communication means. The power meter may contain a vehicle identifier. The power meter may also read a vehicle identifier from the vehicle. The vehicle identifier may be transmitted together with the first measured quantity of power. To this end, the first meter means may combine and transmit information about the first quantity of power together with the vehicle identifier in a data set or may transmit it via the communication means of the vehicle.

According to one embodiment, it is proposed that the second meter means is suitable for remotely reading a power point identifier and a total quantity of power. In this case, the reading may take place for example via the power supply network itself. A separate communication line may also be provided. It is also possible that the reading takes place via a mobile radio network or a telecommunications network.

According to one advantageous embodiment, the computing means is arranged either in a power point or in a centrally arranged computer.

Another subject matter is a device comprising receiving means designed to receive information concerning a first quantity of power together with a vehicle identifier and also a power point identifier together with information concerning a second quantity of power or a total quantity of power, and data processing means for creating a first data set comprising information concerning a second quantity of power and the power point identifier and also a second data set comprising information concerning the first quantity of power and the vehicle identifier. This device may for example be arranged in the central computer or may form the central computer.

In order to be able to determine the second quantity of power from the total quantity of power, it is proposed that the device comprises computing means for subtracting the first quantity of power received by the vehicle from the total quantity of power.

### BRIEF DESCRIPTION OF THE DRAWINGS

The subject-matter will be explained in more detail below with reference to a drawing which shows embodiments. In the drawing:

FIG. 1 shows the schematic structure according to a first embodiment;

FIG. 2 shows a message diagram showing the messages according to the first embodiment;

FIG. 3 schematically shows the structure of a second embodiment;

FIG. 4 shows a message diagram showing the messages according to the second embodiment.

### DETAILED DESCRIPTION OF THE INVENTION

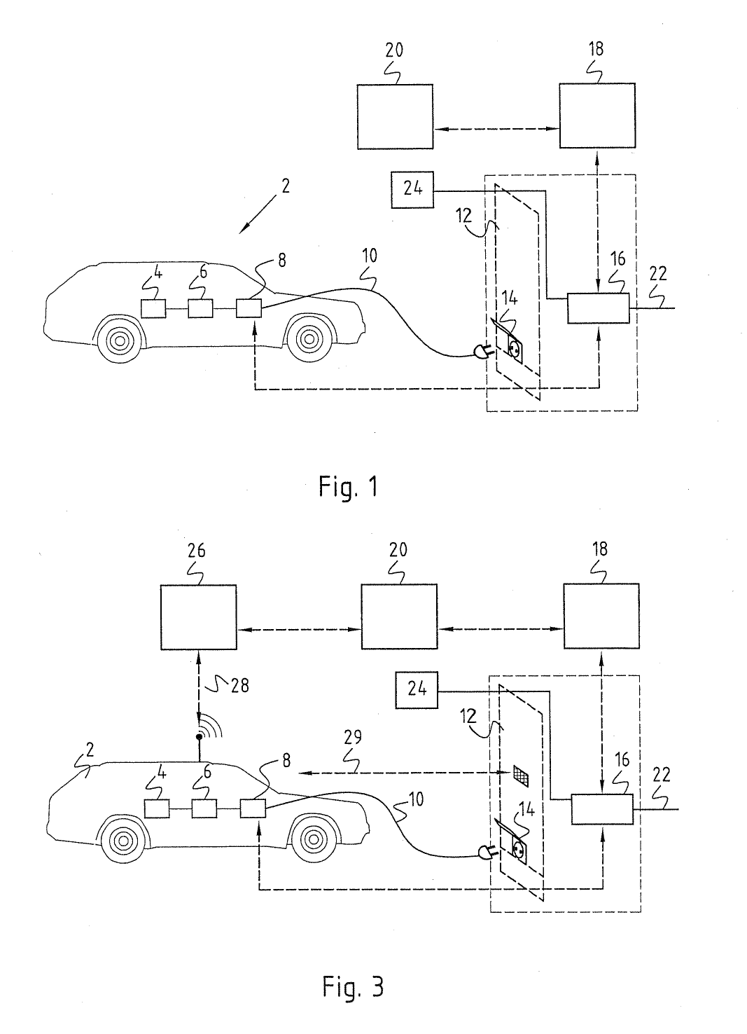

FIG. 1 shows a vehicle 2 which may be a pure electric vehicle or a hybrid vehicle. The vehicle 2 has a battery 4 and also a charging control unit 6. In addition, the vehicle 2 has a calibrated meter 8. The battery 4 is connected via the charging control unit 6 and the meter 8 to a power point 12 by means of a cable 10. The power point 12 has a power socket 14 and also a remotely readable meter 16.

The remotely readable meter 16 is connected to a billing centre 20 via a communication network 18. In addition, the meter 16 is connected to a power supply network 22. The communication network 18 may be part of the power supply network 22, so that for example communication can take place by means of power line communication via the power supply network 22. The communication network 18 may also be a wired or wireless communication network. An IP protocol for example may be used for the communication.

FIG. 1 furthermore shows that additional consumers 24 may be connected to the meter 16, which additional consumers likewise obtain power from the power supply network 22 via the meter 16.

During the charging of the vehicle 2 or of the battery 4 of the vehicle 2 via the cable 10, current flows from the power supply network 22 via the meter 16 and the power socket 14 and also the cable 10, the meter 8 and the charging unit 6 into the battery 4. While back-charging or outputting a current from the vehicle 2 or the battery 4 into the power supply network 22, the flow takes place via the cable 10, the power socket 14 and the meter 16 into the power supply network 22. The sum of the power obtained and dispensed can represent the exchanged quantity of power.

The meter 8 counts the current exchanged with the battery or the quantity of power exchanged with the battery. The meter 16 counts not only this quantity of power but rather at the same time also the quantity of power obtained by the consumers 24. The two quantities of power cannot be separated from one another in the meter 16, so that the meter 16 determines a total quantity of power.

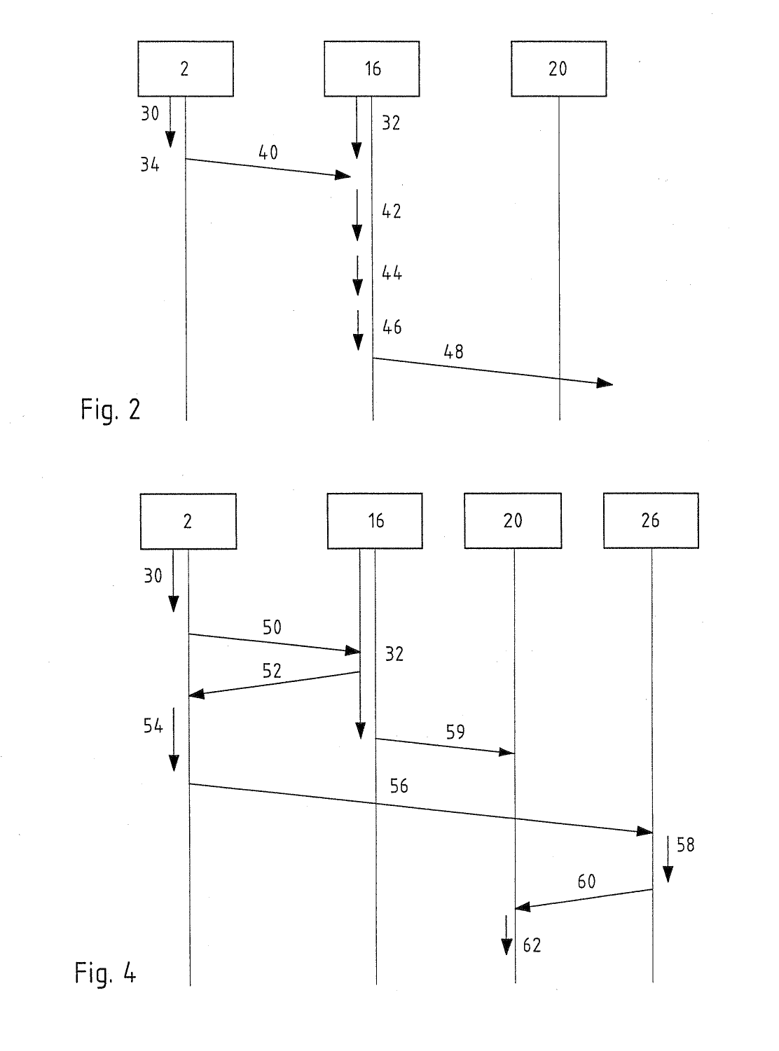

FIG. 2 shows the sequence of the method according to the invention in a message diagram. In FIG. 2, the vehicle 2, the meter 16 and the billing centre 20 are shown as blocks. Lines between these blocks represent the communication between the respective units.

In a first step (30), power is drawn into the vehicle 2 and the first quantity of power is recorded by means of the meter 8. In parallel with this, in a step (32), a total quantity of power which comprises the power obtained by the consumers 24 plus the power obtained by the vehicle 2 is registered in the meter 16.

At the end of a charging process (34), the meter 8 reads a vehicle identifier from the charging unit 6 or from some other unit within the vehicle 2 and combines this vehicle identifier in a first data packet which is transmitted (40) to the meter 16. It is also possible that such a data packet is transmitted (40) from the vehicle 2 or meter 8 to the meter 16 not just at the end of a charging process 34 but rather this communication can take place continuously.

In the data packet, the first quantity of power and the vehicle identifier are encoded. The data packet can be transmitted (40) to the meter 16 either via the cable 10 or via a separate communication cable. A wireless transmission (40) may also take place, for example by means of near field communication (NFC), RFID, WLAN, ZigBee, Bluetooth, infrared or other transmission methods.

In the meter 16, the value of the first quantity of power together with the vehicle identifier is known as a result of the first data packet being received. In addition, the value of the total quantity of power measured in step (32) is also known.

In the meter 16, the first quantity of power is subtracted (42) from the total quantity of power. The second quantity of power is thus determined, which is the difference between the total quantity of power and the first quantity of power and represents the value of the power obtained by the consumer 24 via the meter 16.

In the meter 16 or in the power point 12, for example in a microcomputer, a second data packet is now created (44) which comprises the vehicle identifier and the value of the first quantity of power. In addition, a third data packet is created (46), which contains the value of the calculated second quantity of power and also a power point identifier. The power point identifier may be stored for example in the meter 16 or in another memory within the power point 12.

The second and the third data packet are transmitted (48) to the billing centre 20 via the communication network 18. In the billing centre 20, the second data packet can be used for billing for the quantity of power obtained by the vehicle, and the third data packet can be used for billing for the domestic or industrial power obtained by the consumers 24.

It has been explained that two data packets have been created in steps (42) and (44). It is also possible to omit these steps (42) and (44) and that in step 48 the value of the first quantity of power, the vehicle identifier, the value of the second quantity of power and the power point identifier are transmitted, and the two data packets are calculated and created therefrom in the billing centre 20.

FIG. 3 shows a system according to a second embodiment. As a supplement to the embodiment shown in FIG. 1, here a communication path 28 between the vehicle 2 and a billing centre 26 is shown. This communication path 28 may be wireless for example and may use for example a mobile radio protocol. Furthermore, a communication path 29 between the vehicle 2 and the power point 12 for exchanging a power point identifier is also shown. This communication path 29 may be wireless and may use one of the abovementioned wireless communication paths.

The sequence of the method according to the second embodiment will be presented below in FIG. 4.

Firstly, in a first step (30), the first quantity of power is measured in the vehicle 2 by means of the meter 8. At the end of a charging process, or during the charging process, or at the start of a charging process, the vehicle 2 requests (50) a power point identifier from the power point 12 or the meter 16. The power point 12 or the meter 16 transmits (52) this power point identifier to the vehicle 2. In parallel with this, the power point 12 measures a total power in the meter 16.

The power point identifier is received in the vehicle 2, and a data packet is created (54) which contains the power point identifier, the vehicle identifier and information concerning the first quantity of power. The vehicle transmits (56) this data packet via the communication link 28 to the billing centre 26. In the billing centre 26, the vehicle identifier and the first quantity of power are extracted from the data packet, and a further data set is created (58) which can be used for billing for the power obtained by the vehicle.

During this or at a later or earlier point in time, the power point 12 or the meter 16 transmits (59) the measured total power together with a power point identifier to the billing centre 20. This may take place for example at the end of the charging process, for example once the cable 10 has been removed from the socket 14.

The billing centre 26 transmits (60) the value of the first quantity of power together with the power point identifier, which has been received from the vehicle 2 in step (56), also to the billing centre 20. Thus, for a given charging process, the total quantity of power and the power point identifier are known in the billing centre 20, these having been received from the meter 16. In addition, the first quantity of power which has been obtained from this meter has likewise been received in the billing centre 20. The second quantity of power can thus be calculated (62) in the billing centre 20 from the total quantity of power associated with a power point identifier and the first quantity of power likewise associated with this power point identifier, by subtracting the value of the first quantity of power from the total quantity of power. As a result, the billing centre 20 can now create a further data packet which can be used for billing for the second quantity of power and thus for the quantity of power obtained by the consumers 24. This value of the second quantity of power is thus free from quantities of power obtained by the vehicle 2.

A separation between quantities of power obtained by vehicles and quantities of power obtained for other purposes can thus take place by means of the method according to the subject-matter.

1. Method for determining quantities of power exchanged between a vehicle on a vehicle side and a power point on a power point side, comprising:
registering on the vehicle side a first quantity of power exchanged with the power point;
sending out on the vehicle side information concerning the first quantity of power;
integrally registering on the power point side a total quantity of power formed from the sum of the first quantity of power and also a second quantity of power made available by the power point independently of the vehicle;
subtraction of the first quantity of power received by the vehicle from the total quantity of power in order to determine the second quantity of power.

2. Method of claim 1, further comprising sending out on the vehicle side a vehicle identifier which identifies the vehicle together with information concerning the first quantity of power.

3. Method of claim 1, further comprising reception on the power point side of information concerning the first quantity of power together with a vehicle identifier.

4. Method of claim 1, wherein the step of subtraction of the first quantity of power received from the vehicle from the total quantity of power in order to determine the second quantity of power occurs on the power point side.

5. Method of claim 4, further sending out on the power point side of information concerning the second quantity of power together with a power point identifier and of information concerning the first quantity of power together with a vehicle identifier received on the power point side.

6. Method of claim 5, further comprising reception of the information concerning the second quantity of power together with the power point identifier and of the information concerning the first quantity of power together with the vehicle identifier in a centrally arranged computer.

7. Method of claim 6, further comprising creation of a first data set comprising information concerning the second quantity of power and the power point identifier and also of a second data set comprising information concerning the first quantity of power and the vehicle identifier in the centrally arranged computer.

8. Method of claim 1, further comprising reception on the vehicle side of a power point identifier transmitted by the power point.

9. Method of claim 8, further comprising sending out on the vehicle side of information concerning the first quantity of power together with the power point identifier and a vehicle identifier.

10. Method of claim 9, further comprising reception of information concerning the first quantity of power together with the power point identifier and the vehicle identifier in a centrally arranged computer.

11. Method of claim 1, further comprising sending out on the power point side of information concerning the total quantity of power together with a power point identifier.

12. Method of claim 11, further comprising reception of the information concerning the total quantity of power together with the power point identifier in a centrally arranged computer.

13. Method of claim 12, further comprising subtraction of the first quantity of power received from the vehicle from the total quantity of power in order to determine the second quantity of power in the centrally arranged computer.

14. Method of claim 13, further comprising creation of a first data set comprising information concerning the second quantity of power and the power point identifier and also of a second data set comprising information concerning the first quantity of power and a vehicle identifier in the centrally arranged computer.

15. System for determining quantities of power exchanged between a vehicle on a vehicle side and a power point on a power point side, comprising:
a first meter means on the vehicle side configured to register a first quantity of power exchanged with the power point on the power point side,
sending means on the vehicle side configured to send out information concerning the first quantity of power,
a second meter means on the power point side configured to integrally register a total quantity of power formed from the sum of the first quantity of power and also a second quantity of power made available by the power point independently of the vehicle, and
computing means configured to subtract the first quantity of power received by the vehicle from the total quantity of power in order to determine the second quantity of power.

16. System of claim 15, wherein the first meter means is calibrated.

17. System of claim 15, wherein the second meter means is configured to remotely read a power point identifier and the total quantity of power.

18. System of claim 15, wherein the computing means are arranged in one of the power point or in a centrally arranged computer.

19. Device, comprising:
receiving means configured to receive information concerning a first quantity of power together with a vehicle identifier and also a power point identifier together with information concerning a second quantity of power or a total quantity of power, and
data processing means configured to create a first data set comprising information concerning a second quantity of power and the power point identifier and also a second data set comprising information concerning the first quantity of power and the vehicle identifier, and
computing means configured to subtract the first quantity of power received by the vehicle from the total quantity of power in order to determine the second quantity of power.
